(19) United States
(12) Patent Application Publication
(10) Pub. No.: US 2025/0125382 A1
(43) Pub. Date: Apr. 17, 2025

(54) SEALING DEVICE CONFIGURED TO BE MOUNTED IN A FLUID FLOW CHANNEL OF A FUEL CELL STACK, AND SEALING METHOD

(71) Applicant: SAFRAN POWER UNITS, Toulouse (FR)

(72) Inventors: Romain Quinton, MOISSY-CRAMAYEL (FR); Sofyane Abbou, MOISSY-CRAMAYEL (FR); Patrice Daniel Claude Buso, MOISSY-CRAMAYEL (FR)

(21) Appl. No.: 18/689,576

(22) PCT Filed: Oct. 3, 2022
(86) PCT No.: PCT/EP2022/077486

§ 371 Date: Mar. 6, 2024

(30) Foreign Application Priority Data
Oct. 11, 2021 (FR) FR2110718

(51) Int. Cl. H01M 8/0286; H01M 8/0258; H01M 8/10; H01M 8/1004; H01M 8/241

(52) U.S. Cl. CPC H01M 8/0286; H01M 8/0258; H01M 8/1004; H01M 8/241; H01M 2008/1095

(57) ABSTRACT

An isolation device configured to be mounted in a fluid flow channel of a fuel cell comprising a stack including a plurality of cells aligned along a stack axis and a plurality of fluid flow channels in the stack. The isolation device comprising a peripheral belt configured to block the fluid communication between the flow channel and at least one flow opening of a cell to be isolated in the stack, the belt being deformable between a first configuration, referred to as an idle configuration, and a second configuration, referred to as a constricted configuration, the cross-section of which is smaller than in the first configuration.

### TECHNICAL FIELD

The present invention relates to the field of repairing fuel cells, in particular, on board an aircraft in order to provide propulsion and non-propulsion energy.

A fuel cell makes it possible to produce electrical energy from an electrochemical reaction between different fluids. Conventionally, a fuel cell is supplied with hydrogen and oxygen, which react in the fuel cell to generate electrical energy. A fuel cell comprises a stack comprising a plurality of cells aligned along a stack axis. The stack of the cells enables the electrochemical reaction from the fluids.

Each cell consists of an ion-conductive electrolyte surrounded by two electrodes, which in turn are surrounded by interconnecting plates. By way of example, in the case of a fuel cell of the proton exchange membrane type known by its abbreviation PEMFC for “Proton Exchange Membrane Fuel Cell”, the electrolyte is in the form of a proton-conducting polymer membrane and the electrodes are in the form of a porous medium carrying a catalyst such as platinum. The electrolyte and electrode assembly is called Membrane Electrode Assembly, known by its abbreviation MEA. Each MEA is brought into contact with reactant gases on its two opposite sides (for example hydrogen and oxygen which may be present in the air) through the interconnecting plates to form a cell.

In a known manner, the assembly of two interconnecting plates, belonging to two adjacent cells, is called a bipolar plate. Thus, a bipolar plate is inserted between the cathode of an MEA and the anode of the adjacent MEA. On the one hand, a bipolar plate supplies a first MEA on the anode side with fuel (hydrogen) and, on the other hand, a second MEA on the cathode side with oxidizer (oxygen). In general, each bipolar plate comprises an internal cooling circuit wherein a heat transfer fluid circulates to provide heat or extract the heat produced by the exothermic reaction.

The current generated by the cells is recovered at both ends of the stack by so-called collector conductor plates. The electrical power delivered by the fuel cell is a function of the number of cells (delivered voltage capacity), the active surface area of the cells (delivered current capacity) and the flow rates of the reactant fluids (importance of the electrochemical reaction that produces the current).

The entire stack of cells is kept compressed between two so-called end plates connected by tie rods that hold the assembly and guarantee the sealing of the stack. This sealing is provided by seals inserted between the bipolar plates and the MEAs of the cells. The end plates are conventionally solid because they must apply uniform pressure on the surface of the cells and be dimensionally stable under the effect of internal pressure of the stack and temperature fluctuations.

The reactant and heat transfer fluids are introduced and discharged at the end plates which distribute them in flow channels passing through the stack. These flow channels result from the stack of openings formed in the cells. By way of example, three channels introduce the fluids from one side of the stack (two reactant fluids and one heat transfer fluid if necessary) to transit into the cells while three other channels discharge the fluids from another side of the stack.

In a known manner, a fuel cell comprises a stack comprising a plurality of cells aligned along a stack axis. Tie rods connect an outer portion of the end plates peripherally so as to apply a constant compressive force on the stack. The end plates comprise flow lines that lead into the flow channels of the stack.

During the electrochemical reaction in the fuel cell, the reactant fluids become charged with traces of acid, which are part of the composition of MEAs. These traces of phosphoric acid are present in the flow channels corresponding to the outlets of the two fuel fluid circuits, in particular, in the form of water vapor in the case of a high-temperature fuel cell. This acid may crystallize, especially during a fuel cell start/stop step during which the temperature is below the normal operating temperature, which may block the flow channels. Such a blockage may cause damage which may lead to hot spots with the risk of perforation of the MEA. In addition to a loss of efficiency of the fuel cell, the likelihood of fire and leakage risks is increased.

If one or more cells are damaged, it is necessary to isolate these cells from the flow of reactant fluids so that they no longer produce electricity or allow fluid communication between reactants. From an electrical point of view, these cells must be shunted so as not to interrupt the electrical generation in the stack.

To reach a defective cell, it is necessary to descend along each of the channels to intervene individually on each of the flow openings of the defective cell. This intervention is complex given the height of the channels (up to 300 mm) and their cross-section (from 300 to 1000 mm²).

A method for repairing a defective cell is known in the prior art during which an electrical shock is applied to the defective cell in order to puncture the membrane. The flow openings are sealed individually by depositing resin.

Although attractive in theory, this solution is complex to implement. One objective of the present invention is to enable a defective cell to be isolated from a stack in a practical and quick manner.

### DESCRIPTION OF THE INVENTION

The invention relates to an isolation device configured to be mounted in a fluid flow channel of a fuel cell comprising a stack comprising a plurality of cells aligned along a stack axis and a plurality of fluid flow channels in the stack.

The isolation device is remarkable in that it comprises a peripheral belt configured to block the fluid communication between the flow channel and at least one flow opening of a cell to be isolated from the stack, the belt being deformable between a first configuration, referred to as an idle configuration, and a second configuration, referred to as a constricted configuration, the cross-section of which is smaller than in the first configuration.

Preferably, such an isolation device may be conveniently positioned at the desired position in a flow channel in order to isolate a cell from the stack. A peripheral belt provides a localized sealing while allowing fluid to circulate through the belt to supply the other cells. Its deformable nature allows convenient and quick positioning without risk of damaging the inner surface of the flow channel. The belt makes it possible to conveniently and simultaneously seal a plurality of flow openings of a cell.

Preferably, in the first configuration, the section of the belt is substantially analogous to the section of the flow channel wherein the isolation device is configured to be mounted. Thus, the belt naturally, without excessive stress or deformation, conforms to the inner surface of the flow channel, which makes it possible to seal the cell conveniently and without the risk of damage in the vicinity.

According to one aspect, the isolation device comprises a spring member configured to constrain the belt in the first configuration. Thus, the belt is automatically deployed when the operator is not constraining the belt. This is particularly advantageous when the cell to be isolated is far from the access opening of the flow channel and easy handling of the isolation device is desired.

Preferably, the spring member is in the form of a spring leaf of which the design is simple. A spring leaf may be positioned on the inner surface of the belt so as to avoid contact with the inner surface of the channel.

Preferably, the isolation device comprises an indexing member configured to ensure precise positioning of the isolation device in the flow channel, in particular, opposite an opening of one or more flow openings of the cell to be isolated. Preferably, a cell comprises two seals on either side of the flow openings, the indexing member is configured to cooperate with the seals.

This is particularly advantageous for providing precise positioning when the cell to be isolated is far from the access opening of the flow channel. Preferably, the indexing member is in the form of a peripheral tongue extending protruding from the outer surface of the belt. Thus, the indexing member allows cooperation by form-fitting with the seals.

Preferably, the isolation device comprises a plurality of guiding members configured to cooperate with an inner surface of the flow channel. Preferably, the flow channel having a section defining a plurality of corners, the guiding members are configured to cooperate with the corners of the flow channel. As a result, the belt is positioned angularly precisely in the channel, ensuring optimum sealing.

The invention also relates to a fuel cell assembly comprising a stack comprising a plurality of cells aligned along a stack axis and a plurality of fluid flow channels in the stack and an isolation device, such as previously presented, positioned in the flow channel to block the fluid communication between the flow channel and at least one cell to be isolated from the stack.

Preferably, the stack comprises an alternation of bipolar plates and membrane electrode assemblies defining the cells of the stack. The isolation device is positioned in the flow channel in such a way as to block the fluid communication between the flow channel and a bipolar plate to be isolated. Thus, the supply of fluid to the bipolar plate is stopped.

Preferably, the isolation device has a thickness, defined according to the stack axis in the mounted position, which is greater than the thickness of a bipolar plate so as to prohibit any flow of fluid therein.

According to a preferred aspect, seals are inserted between the bipolar plates, the seals extend protruding into the flow channel so as to participate in the tight sealing of the bipolar plate.

Preferably, the indexing member cooperates with the seals to provide a tight isolation. Thus, the positioning of the isolation device is precise to tightly isolate a bipolar plate.

The invention also relates to a method of isolating a cell from a fuel cell comprising a stack comprising a plurality of cells aligned along a stack axis and a plurality of fluid flow channels in the stack, the method comprising the steps consisting of:
Deforming the isolation device, such as presented previously, from the first configuration to the second configuration, so as to reduce the cross-section thereof so that it is smaller than the cross-section of the flow channel,
Moving said isolation device according to the second configuration in the flow channel so as to align it with at least one flow opening of the cell to be isolated and
Releasing the constraint to deform the isolation device from the second configuration to the first configuration so as to press the belt against an inner surface of the flow channel in order to block the fluid communication between the flow channel and the flow opening of the defective cell.

Preferably, the isolation method comprises a step of electrically connecting the cell to be isolated to another cell of the stack, preferably, an adjacent cell. Thus, the defective cell is electrically isolated in order to allow the stack to supply an electrical voltage.

### DESCRIPTION OF THE FIGURES

The invention will be better understood upon reading the following description, given as an example, and by referring to the following figures, given as non-limiting examples, wherein identical references are given to similar objects.

FIG. 1 is a schematic representation of a fuel cell according to the invention.

FIG. 2 is a first schematic cross-sectional representation of a fluid flow channel with an isolation device.

FIG. 3 is a second schematic cross-sectional representation of a fluid flow channel with an isolation device.

FIG. 4 is a third schematic cross-sectional representation of a fluid flow channel with an isolation device.

FIG. 5 is a first schematic representation of an isolation device.

FIG. 6 is a second schematic representation of an isolation device.

It should be noted that the figures set out the invention in detail to implement the invention, wherein said figures may of course be used to better define the invention if necessary.

### DETAILED DESCRIPTION OF THE INVENTION

The invention relates to the field of fuel cells of the proton-exchange membrane type known by its abbreviation PEMFC for “Proton-Exchange Membrane Fuel Cell”. Preferably, the fuel cell is on board an aircraft in order to supply power to propulsion equipment.

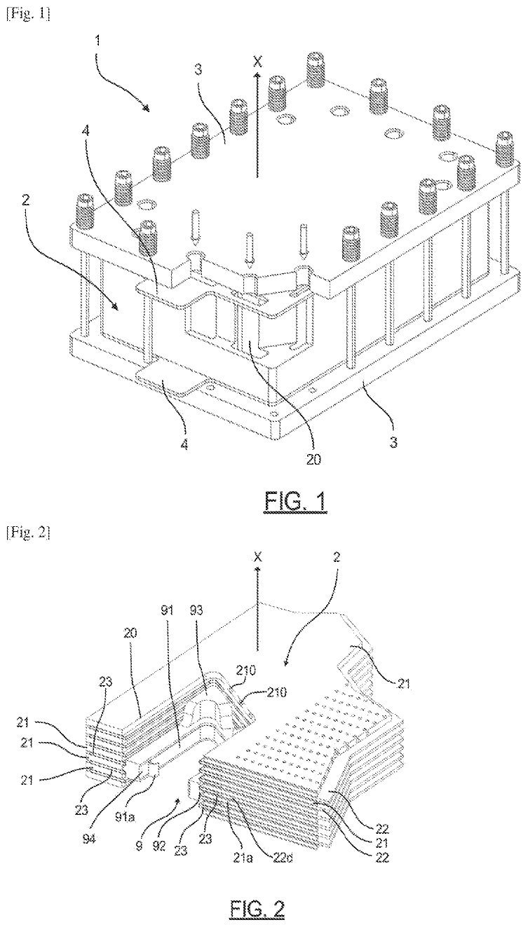

In reference to [FIG. 1], a fuel cell 1 is shown comprising a stack 2 comprising a plurality of cells aligned along a stack axis X. Each cell comprises a plurality of fluid flow openings, said fluid flow openings being aligned parallel to the stack axis X in order to form a plurality of fluid flow channels 20 in the stack 2.

The stack 2 of the cells allows the electrochemical reaction from fluids, in particular, hydrogen and oxygen. In this example, each cell comprises a Membrane Electrode Assembly, known by its abbreviation MEA. Each MEA is brought into contact with reactant gases on its two opposite sides (for example hydrogen and oxygen which may be present in the air) through the interconnecting plates to form a cell. In a known manner, the assembly of two interconnecting plates, belonging to two adjacent cells, is called a bipolar plate. Thus, a bipolar plate is inserted between the cathode of an MEA and the anode of the adjacent MEA. Thus, a bipolar plate supplies on the one hand a first MEA on the anode side with fuel (hydrogen) and, on the other hand, a second MEA on the cathode side with oxidizer (oxygen). In general, each bipolar plate comprises an internal cooling circuit wherein a heat transfer fluid circulates to provide heat or extract the heat produced by the exothermic reaction. Such a stack 2, formed of an alternation of MEAs and bipolar plates, is known from the prior art and will not be presented in more detail.

In this example, in reference to [FIG. 1], the fuel cell 1 further comprises collector plates 4, positioned at the ends of the stack 2, so as to collect the current generated by the cells. In a known manner, the electrical power delivered by the fuel cell 1 is a function of the number of cells (delivered voltage capacity) and the flow rates of the reactant fluids (importance of the electrochemical reaction that produces the current).

In reference to [FIG. 1], the fuel cell 1 further comprises two end plates 3 placed at the ends of the stack 2 along the stack axis X and a plurality of traction members connecting the end plates 3 to each other in order to compress the stack 2.

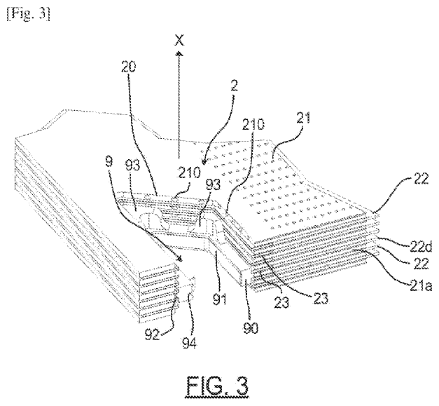

In reference to FIGS. 2 to 6, an isolation device 9 according to the invention will be presented to isolate a defective cell from a stack 2.

As a reminder, as mentioned previously, a cell comprises a membrane electrode assembly MEA and two interconnecting plates. Two adjacent interconnecting plates form a bipolar plate.

In reference to FIGS. 2 to 4, the stack 2 comprises an alternation of bipolar plates 21 and membrane electrode assemblies MEA 22 to generate electrical energy. The stack 2 comprises several flow channels 20 extending along the stack axis X and placing each of the bipolar plates 21 in fluid communication which then supply the MEAs 22. Seals 23 are provided between the bipolar plates 21 in order to provide a seal between them. The seals 23 are elastic and contribute to the indexing of the isolation device 9 as will be presented below. Preferably, the seals 23 extend protruding into the flow channel 20, which facilitates the formation of a seal with the isolation device 9. Each bipolar plate 21 comprises flow openings 210 leading into the flow channels 20 in order to allow the supply of the bipolar plates 21 with the fluids circulating in the flow channels 20.

In practice, a flow channel 20 supplies reactant fluid to a single side of a bipolar plate 21 and the MEA 22 in contact therewith, the other side being supplied by another reactant fluid via another flow channel 20.

In this example, in reference to FIGS. 2 to 4, a bipolar plate 21 is configured to supply the MEA 22 located above it for this flow channel 20. Of course, this could be different for another flow channel 20.

When an MEA 22d is defective, the latter may create a hot spot and pose risks to the fuel cell 1. It is therefore necessary to isolate the cell to which the defective MEA 22d belongs, in particular, the bipolar plate 21a that supplies it. In this example, the bipolar plate 21a that supplies the defective MEA 22d is located below the defective MEA 22d.

In this example, stopping the supply of a single reactant fluid from a defective MEA 22d is sufficient to isolate it. Nevertheless, it goes without saying that the supply of all reactant fluids of the defective MEA 22d could be stopped by using an isolation device 9 in another flow channel 20. Preferably, the isolation is carried out in the flow channel 20 conducting the hydrogen.

According to the invention, in reference to FIGS. 2 to 4, an isolation device 9 according to one embodiment of the invention is used in order to seal all the fluid flow openings 210 of at least one bipolar plate 21 adjacent to the defective MEA 22d. In this example, the bipolar plate 21 located below the defective MEA 22d will be isolated since it is the latter that supplies the defective MEA 22d. Subsequently, the bipolar plate to be isolated is referenced as 21a.

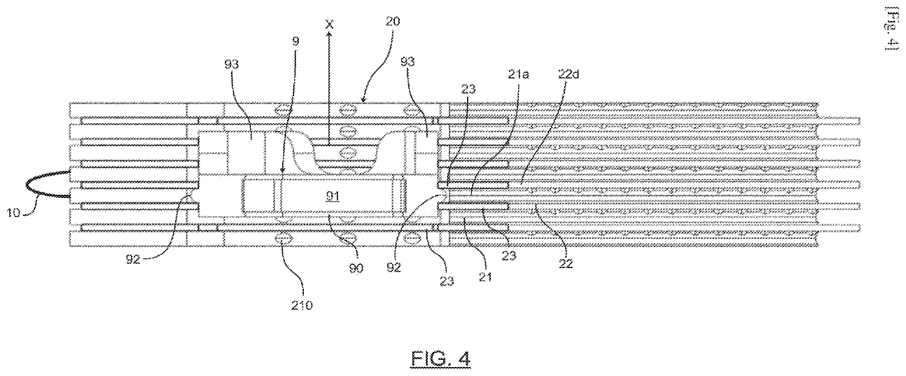

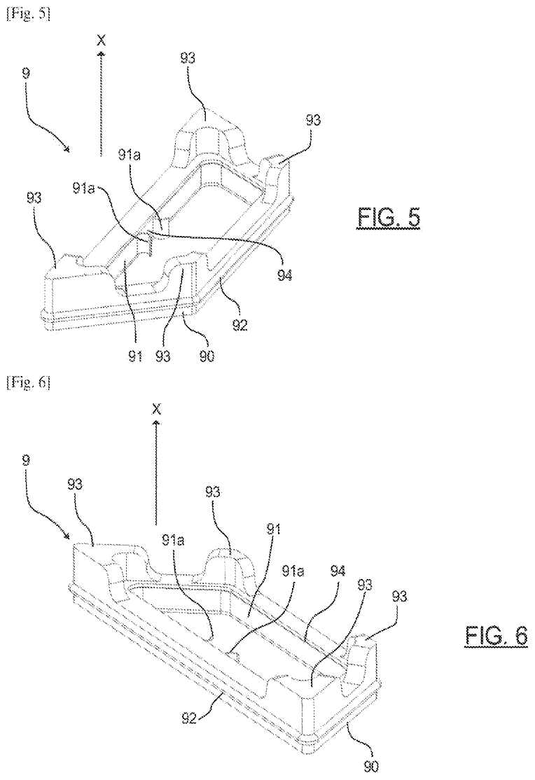

In reference to FIGS. 5 and 6, the isolation device 9 comprises a peripheral belt 90. The belt 90 has a thickness, defined according to the stack axis X in the mounted position, which is greater than the thickness of a bipolar plate 21 so as to prohibit any flow of fluid in the latter. In particular, the belt 90 makes it possible to cooperate with the seals 23 that are adjacent to the bipolar plate to be isolated 21a as shown in [FIG. 4]. Thus, the flow channel 20 is no longer in fluid communication with the flow openings 210 of the bipolar plate to be isolated 21a. The bipolar plate 21 is no longer supplied with fluid and may no longer supply the defective MEA 22d. Due to its peripheral shape, the belt 90 always allows the supply with fluid of the bipolar plates 21 located above and below the isolation device 9, the fluid being able to circulate in the center of the belt 90.

Preferably, the belt 90 is configured to be deformable between a first configuration, referred to as an idle configuration, and a second configuration, referred to as a constricted configuration, the cross-section of which is smaller than in the first configuration. Preferably, the section of the first configuration is substantially analogous to the section of the flow channel 20 wherein the isolation device 9 is configured to be mounted so as to intimately conform to its contour. Preferably, the belt 90 is formed in a deformable elastic material, for example, of elastomer or rubber which further has good sealing performance.

Preferably, the isolation device 9 comprises a spring member 91 configured to constrain the belt 90 in the first configuration. In this example, as shown in FIGS. 5 and 6, the spring member 91 is in the form of a spring leaf. Preferably, the spring member 91 is mounted in a groove 94 formed in the belt 90, in particular, in an inner face so as not to come into contact with the inner surface of a flow channel 20. The spring member 91 preferably comprises projecting ends 91a allowing the operator to conveniently constrain the spring member 91 in order to deform the belt 90 in the second configuration.

Such a spring member 91 is not mandatory and the belt 90 could deform the seals 23, elastically, when fitting the isolation device 9.

Preferably, the isolation device 9 comprises an indexing member 92 configured to be housed between two seals 23 so as to provide precise positioning of the isolation device 9 in the flow channel 20, i.e., aligned with the flow openings 210 of the bipolar plate to be isolated 21a. In this example, the indexing member 92 is in the form of a peripheral tab extending protruding from the outer surface of the belt 90. Preferably, the indexing member 92 is derived from material of the belt 90, which makes it possible to reduce its manufacturing cost and to maintain its sealing properties. Such an indexing member 92 advantageously makes it possible to be indexed with respect to the seals 23 and to deform them. A tongue shape makes it possible to optimize contact with the seals 23 to improve sealing.

In reference to FIGS. 5 and 6, the isolation device 9 comprises a plurality of guiding members 93 configured to cooperate with the inner surface of the flow channel 20 without however completely blocking the flow openings 210 of the bipolar plates adjacent to the bipolar plate to be isolated 21a. In this example, the guiding members 93 are elementary and non-continuous so as to permit fluid flow between them. The guiding members 93 are preferably positioned at each corner of the shape defined by the section of the flow channel 20. In this example, the flow channel 20 has a parallelogram section defining four corners. Also, as shown in FIGS. 5 and 6, the isolation device 9 comprises four guiding members 93 in order to provide rigidity and improve the cooperation of the isolation device 9 with the concave zones (corners) of the flow channel 20. A precise guiding and positioning substantially improves sealing. As shown in FIGS. 5 and 6, the guiding members 93 are in the form of portions extending vertically protruding from an upper wall of the belt 90 so that they may be conveniently manipulated by an operator. Preferably, the guiding members 93 are derived from material of the belt 90, which makes it possible to reduce its manufacturing cost.

An example of implementation of a method for isolating a cell of a stack 2 will now be presented. In this example, in reference to [FIG. 4], a flow channel 20 comprises a defective membrane electrode assembly (MEA) 22d which must be isolated. The flow channel 20 extends vertically and is accessible from its upper opening. Preferably, the isolation is carried out in the flow channel 20 conducting the hydrogen.

The method comprises a step of deforming the isolation device 9, from a first configuration to a second configuration, so as to reduce its cross-section so that it is smaller than the cross-section of the flow channel 20. The deformation is performed simply by the operator by acting on the spring member 91, in particular on the ends 91a of the spring member 91.

The method comprises a step of moving the isolation device 9 according to the second configuration in the flow channel 20 such that the indexing member 92 is aligned with the bipolar plate to be isolated 21a located under defective MEA 22d.

The method comprises a step of releasing the constraint applied to the isolation device 9 which, in the idle position, regains the first configuration with an idle section which is substantially equal to that of the flow channel 20. When the constraint is released, the belt 90 presses against the seals 23 so as to prevent any flow of fluid between the flow channel 20 and the bipolar plate to be isolated 21a located under defective MEA 22d. The presence of the indexing member 92 allows precise positioning between the seals 23 and optimal sealing cooperation. The guiding members 93 enable the expansion of the belt 90 to be guided in the first configuration by positioning itself in the concave zones of the flow channel 20, in particular in its 4 corners. This limits the risk of a positioning defect of the isolation device 9 in particular when the flow channel 20 has a large height and defective MEA 22d is far from the access to the flow channel 20.

Once the isolation device 9 is in position, any fluid circulation between the flow channel 20 and the bipolar plate 21a located under defective MEA 22d is stopped, which makes it possible to prevent a supply of the MEAs 22 positioned adjacent to the bipolar plate 21a. So, defective MEA 22d is no longer supplied, which prevents the formation of a hot spot.

Preferably, the method comprises a step of electrically connecting adjacent bipolar plates 21 to defective MEA 22d so as to provide electrical continuity in the fuel cell 1. Preferably, an electrical cable 10 is used to electrically connect the bipolar plates 21 as shown in [FIG. 4]. In other words, the bipolar plate 21a is no longer fluidically supplied and is electrically shunted, which provides an isolation of the defective cell allowing the fuel cell 1 to operate with one cell less.

When using the fuel cell 1, fluid flows into the flow channel 20 to supply the cells that are not isolated in order to produce electrical energy. The fluid pressure makes it possible to constrain the belt 90 radially outward to press it against the flow openings 210, which provides optimal sealing.

An isolation of a cell the MEA 22d of which is defective has been presented, but it goes without saying that the invention also applies to one or more cells a bipolar plate 21 of which is defective. The isolation device 9 advantageously makes it possible to stop the fluid supply of said bipolar plate 21 and of the associated cell.

When several adjacent MEAs 22 are defective, the isolation device 9 has a greater height and an indexing member 92 for each bipolar plate to be isolated.

1. An isolation device configured to be mounted in a fluid flow channel of a fuel cell comprising a stack comprising a plurality of cells aligned along a stack axis and a plurality of fluid flow channels in the stack, the isolation device comprising a belt which is peripheral and configured to block fluid communication between the flow channel and at least one flow opening of a cell to be isolated from the stack, the belt having a cross-section defined as a surface delimited by the periphery of the belt, the belt being deformable between:
a first configuration in which the cross-section of the belt is substantially analogous to a cross-section of the flow channel, wherein the isolation device is configured to be mounted, and
a second configuration in which the cross-section of the belt is smaller than the cross-section of the belt in the first configuration.

2. The isolation device according to claim 1, wherein the isolation device comprises a spring member configured to constrain the belt in the first configuration.

3. The isolation device according to claim 1, further comprising an indexing member configured to provide precise positioning of the isolation device in the flow channel.

4. The isolation device according to claim 1, further comprising a plurality of guiding members configured to cooperate with an inner surface of the flow channel.

5. The isolation device according to claim 4, wherein the flow channel includes a section defining a plurality of corners, and wherein the guiding members are configured to cooperate with the corners of the flow channel.

6. A fuel cell assembly comprising the stack comprising the plurality of cells aligned along the stack axis and the plurality of fluid flow channels in the stack and the isolation device, according to claim 1, positioned in the flow channel to seal the fluid communication between the flow channel and at least one cell to be isolated from the stack.

7. The fuel cell assembly according to claim 6, wherein the stack comprises an alternating arrangement of bipolar plates and membrane electrode assemblies defining the cells of the stack, wherein the isolation device is positioned in the flow channel so as to block the fluid fluid communication between the flow channel and a bipolar plate of the bipolar plates to be isolated.

8. The fuel cell assembly according to claim 7, wherein seals are inserted between the bipolar plates, and wherein the seals extend protruding into the flow channel.

9. The fuel cell assembly according to claim 8, wherein the isolation device comprises an indexing member configured to ensure a precise positioning of the isolation device in the flow channel, and wherein the indexing member cooperates with the seals to provide a tight isolation.

10. A method of isolating a cell from a fuel cell, comprising:
mounting an isolation device in a fluid flow channel of the fuel cell comprising a stack comprising a plurality of cells aligned along a stack axis and a plurality of fluid flow channels in the stack, the isolation device comprising a belt which is peripheral and configured to block fluid communication between the flow channel and at least one flow opening of a cell to be isolated from the stack, the belt having a cross-section defined as a surface delimited by the periphery of the belt, the belt being deformable between: a first configuration in which the cross-section of the belt is substantially analogous to a cross-section of the flow channel, wherein the isolation device is configured to be mounted, and a second configuration in which the cross-section of the belt is smaller than the cross-section of the belt in the first configuration;
deforming the isolation device from the first configuration to the second configuration, so as to reduce its cross-section so that it is smaller than the cross-section of the flow channel,
moving said isolation device according to the second configuration in the flow channel so as to align the isolation device with at least one flow opening of the cell to be isolated, and
releasing the constraint to deform the isolation device from the second configuration to the first configuration so as to press the belt against an inner surface of the flow channel in order to block the fluid communication between the flow channel and the flow opening of a defective cell.

11. The method of isolating according to claim 10 further comprising:
electrically connecting the cell to be isolated to another cell of the stack.

12. The method of isolating according to claim 10, further comprising: electrically connecting the cell to be isolated to another cell of the stack, wherein the another cell of the stack is an adjacent cell.
